(19) United States
(12) Patent Application Publication
(10) Pub. No.: US 2005/0199483 A1
(43) Pub. Date: Sep. 15, 2005

(54) System and method for the on-demand on-line treatment of water

(75) Inventor: Dan J. Kroll, Fort Collins, CO (US)

Correspondence Address: SETTER OLLILA, LLC, 2060 BROADWAY, SUITE 300, BOULDER, CO, 80302, US

(73) Assignee: HACH COMPANY

(21) Appl. No.: 10/946,762

(22) Filed: Sep. 22, 2004

Related U.S. Application Data
(60) Provisional application No. 60/553,640, filed on Mar. 15, 2004.

(51) Int. Cl. B01J 19/08

(52) U.S. Cl. 204/157.15; 422/186.3

(57) ABSTRACT

A system and method for the on-demand on-line treatment of water is disclosed. The system uses ultra high energy UV light coupled with the introduction of a strong oxidant to induce photo-catalytic degradation of chemical compounds and biocidal activity. When an agent or substance is detected in the water the treatment system would be activated.

### RELATED APPLICATIONS

This application claims the benefit of U.S. provisional application No. 60/553,640 filed on Mar. 15, 2004 entitled “A System and Method for the On-Demand On-Line Treatment of Water,” which hereby is incorporated by reference into this application.

### BACKGROUND OF THE INVENTION

1. Field of the Invention

The invention is related to the field of water treatment, and in particular, to on-line treatment of water.

2. Statement of the Problem

Most modern water systems in the United States and around the world rely upon centralized treatment and then final distribution of the finished water through an elaborate network of piping. This network of pipes leading from the treatment plant to the end user is known as the distribution system. Once the water has entered the distribution network, most systems rely upon the integrity of the pipes and small chlorine residual to maintain water quality until delivery.

The integrity of the distributions system is not absolute and can be breeched either intentionally or accidentally by pipe degradation, breaks in the line, or back flow events. Back flow events occur when a substance is accidentally or intentionally injected into the system across the pressure gradient in the pipes from a source of pressure adequate to overcome that in the pipes. This can occur though inadvertent cross connections and siphoning or through a deliberate attempt to contaminate the distribution system.

The drinking water distribution system is one of the nation's key infrastructure assets that have been deemed vulnerable to deliberate terrorist attacks. While the threat to reservoir systems and water sources is deemed to be minimal, the vulnerability of the drinking water distribution systems to accidental or deliberate contamination due to a backflow event is now a well-recognized possibility. The myriad possible points of incursion into a distribution system, and the ease of mounting a backflow event, combined with the fact that little or no quality monitoring or treatment occurs after water has left the treatment plant, makes the danger of such an attack acute.

A system could be compromised through an assault anywhere in the distribution system by introducing a backflow event using low cost pumps that are readily available from many home improvement stores or over the Internet. The injection point could be the basement of a private home or rental property anywhere in the system. Key infrastructure and icon locations such as hospitals, large hotels, sporting venues, police stations, firehouses, military bases and government buildings could be targeted.

Much Federal and private research money has been spent on detecting such an event if it were to occur. Little or no thought however has been placed on what actions should take place if such an event is detected. There has not here to fore been devised a reliable method for responding to and treating such an event if it were detected. What is needed is a rapid response system deployable in the distribution system that is capable of treating the wide variety of contaminants that may be encountered on a real time basis.

Therefore there is a need for a system and method for providing on-demand on-line treatment of water.

### SUMMARY OF THE INVENTION

A system and method for the on-demand on-line treatment of water is disclosed. The system uses ultra high energy UV light coupled with the introduction of a strong oxidant to induce photo-catalytic degradation of chemical compounds and biocidal activity. When an agent or substance is detected in the water the treatment system would be activated.

### BRIEF DESCRIPTION OF THE DRAWINGS

FIG. 1 is a functional block diagram of a treatment system in an example embodiment of the invention.

FIG. 2 is a functional block diagram of a treatment system, including an upstream sensor, in another example embodiment of the invention.

FIG. 3 is a functional block diagram of a treatment system, including an upstream and downstream sensor, in another example embodiment of the invention.

FIG. 4 is a flow chart for a method of treating water in an example embodiment of the invention.

FIG. 5 is a flow chart for a method of treating water in another example embodiment of the invention.

FIG. 6 is a flow chart for a method of treating water in another example embodiment of the invention.

FIG. 7 is a flow chart for a method of treating water in another example embodiment of the invention.

### DETAILED DESCRIPTION OF THE PREFERRED EMBODIMENT

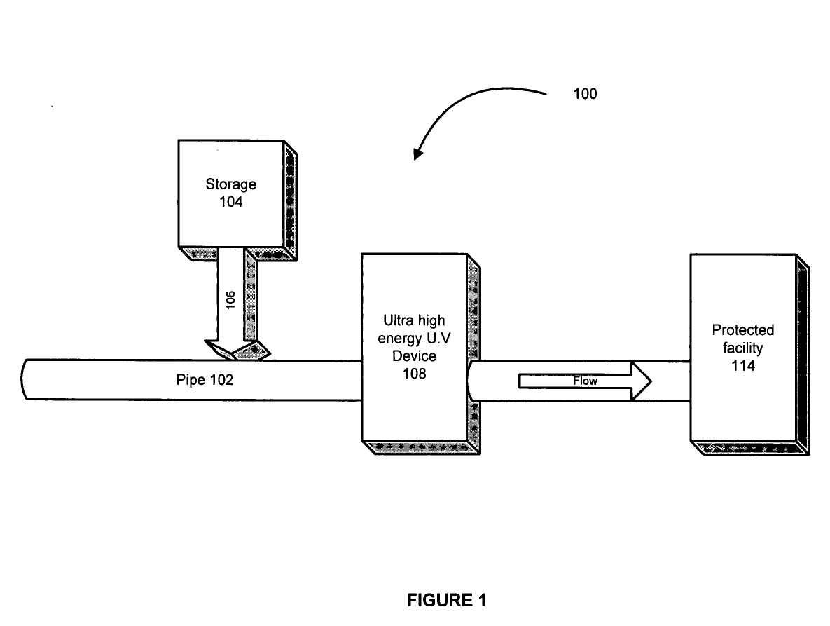

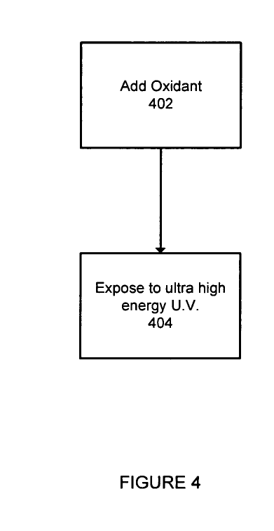

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a functional block diagram of a treatment system (100) deployed upstream of a facility to be protected (114) in one example embodiment of the invention. The system would couple to a pipe (102) in the water distribution system. The system would comprise a storage area (104) for storing an oxidant that is used by the system. The storage area (104) would be coupled to a metering and feed device (106) used to control the flow rate of oxidant into the water distribution system. The system would comprise an ultra high energy ultra violet (UV) source (108) configured to expose the water and oxidant mix to ultra high levels of UV energy. Under normal conditions the system (100) could be in an inactive state where the water would flow through the system without change. When an event occurred, for example a substance was detected in the water supply, the system could be activated. When activated the system would add a stream of a predetermined amount of oxidant to the water flow (402) and expose the water to ultra high levels of UV energy (404). The predetermined amount of oxidant may depend on the oxidant being used and the amount of UV energy may also depend on the oxidant being used. Both the amount of oxidant and the amount of UV energy may depended on the type and concentration of the contaminant detected.

In one example embodiment of the invention, the ultra high levels of UV energy would be generated using pulsed UV light. Typically pulsed UV uses xenon flash lamps to deliver ultra high energy pulses of UV light that contain orders of magnitude more energy than standard UV technologies. (Peak UV power output Pulsed=6,000,000 Watts, Mid-pressure UV Lamp 494 Watts, Low Pressure UV Lamp 27 Watts) (Average UV power output Pulsed=2400 Watts, Mid-pressure UV Lamp 494 Watts, Low Pressure UV Lamp 27 Watts). Studies have shown that pulsed UV is capable of delivering UV dosages that are capable of destroying a wide variety of biological contaminants including very hard to destroy organisms such as Anthrax spores. In addition to the power provided by pulsed UV technology, the size of pulsed UV units are orders of magnitude smaller than conventional UV systems designed to treat an equal quantity of water. Also the ability of pulsed UV to be effective in an instant-on mode with no warm up time, as opposed to conventional UV which can take up to an hour to fully power up, may be preferable in an on-demand system. Another advantage of pulsed UV is that pulsed UV typically contains a broader spectrum of energy than continues UV sources. The broader spectrum of energy causes different chemical bonds to break during exposure. One example of a pulsed UV source is the LightStream Technologies, inc. LSi product. Some UV sources may be able to very the wavelength of the peak UV energy to match the bond energy for the substance detected in the water.

Pulsed UV in and of itself may not be completely effective against all compounds. Research has shown that the combination of pulsed UV with a sensitizer can increase its biocidal efficiency. Most of these sensitizers tend to be strong oxidants such as hydrogen peroxide. Oxidants are also known to degrade chemicals. The combination of a strong oxidant with pulsed UV reduces the time needed to destroy contaminants. See table below.

Testing revealed the following destruction times:

| Photosensitizer + Pulsed UV light | | |
|---|---|---|
| Anthrax spores | 75 | seconds |
| E. coli bacteria | 75 | seconds |
| Salmonella | 75 | seconds |
| Water borne virus simulants | 75 | seconds |
| Photosensitizer only − No Pulsed UV light | | |
| Anthrax spores | 8 | minutes |
| E. coli bacteria | 8 | minutes |
| Salmonella | 8 | minutes |
| Water borne virus simulants | 8 | minutes |

There are many candidates for the strong oxidant required to enhance the degradation efficiency of pulsed UV.

Comparative Oxidation Potential − mVs⁸

| | |
|---|---|
| Fluorine | 3.0 |
| Ozone | 2.1 |
| Hydrogen Peroxide | 1.8 |
| Potassium Permanganate | 1.7 |
| Chlorine Dioxide | 1.5 |
| Chlorine | 1.4 |

To be a useful sensitizer/oxidant in an on-line deployed distributed treatment system a chemical needs to have a high oxidation potential, be safe for addition to water used for human consumption, be safe to store for long periods without presenting a danger or losing its effectiveness, be able to be instantly deployed and be relatively inexpensive.

Fluorine is not safe for human consumption unless converted to fluoride which has no oxidation power, Hydrogen Peroxide, Chlorine Dioxide and Chlorine may be difficult to store safely, Potassium Permanganate rapidly degrades, may be difficult to store safely and imparts an unpleasant purple color to water, and Ozone does not as yet exist in an instant on form. In a preferred embodiment the sensitizer/oxidant Potassium peroxymonopersulfate (Oxone®) will be used.

The active ingredient of the Dupont product Oxone® is potassium peroxymonopersulfate, KHSO₅, commonly known as potassium monopersulfate, which is present as a triple salt with the formula 2KHSO₅.KHSO₄.K₂SO₄ (potassium hydrogen peroxymonosulfate sulfate). The oxidation potential of Oxone® is derived from its peracid chemistry; it is the first neutralization salt of peroxymonosulfuric acid H₂SO₅ (also known as Caro's acid).

The standard electrode potential (E⁰) of Oxone® is shown in the following reaction:
HSO₄⁻+H₂O→HSO₅⁻+2H⁺+2e⁻−1.44 v

This potential is high enough for many room temperature oxidations to occur. Oxone® is a relatively stable peroxygen, and loses less than 1 percent of its activity per month under storage. Oxone® is also readily soluble and can be rapidly dissolved at >250 g/L when needed to form a concentrated solution that can be metered into a system with standard water treatment equipment to the desired level. Even after dissolution the compound is fairly stable and can be stored for several weeks.

Oxone® is not currently approve for addition to drinking water supplies but has a long history in the pool and spa industry as a secondary oxidant for shocking pools where its non-toxicity and safety as opposed to chlorine are well documented. Oxone® has a low order of toxicity when taken internally, based on animal studies. The LD-50 for rats is 2250 mg/Kg while the corresponding LD-50 for Sodium Hypochlorite is 8.9 mg/kg. Another advantage for using Oxone® as the oxidant is that the amount of oxidant needed to treat a large volume of water fits in a relatively small space. For example, 24 cubic feet (the size of a small desk 2×2×6) of Oxone® would treat approximately 4.4 million gallons of water at 50 mg/per L. The amount of chlorine needed to treat the same amount of water would fill several rooms.

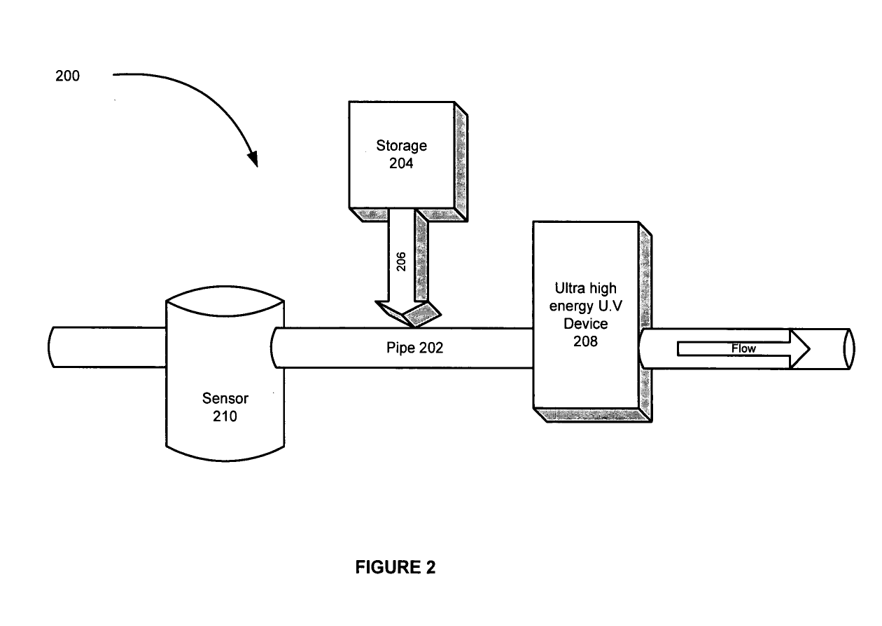

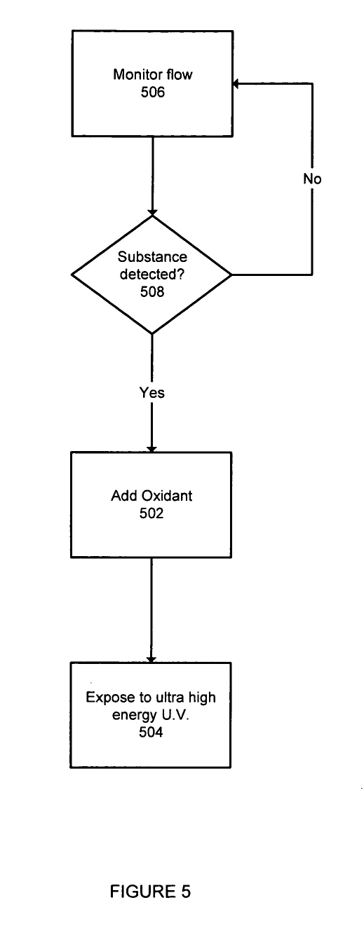

FIG. 2 shows another example embodiment of the current invention. The system (200) would couple to a pipe (202) in the water distribution system. The system would comprise a storage area (204) for storing an oxidant that is used by the system. The storage area (204) would be coupled to a metering and feed device (206) used to control the flow rate of oxidant into the water distribution system. The system would comprise an ultra high energy (UV) source (208) configured to expose the water and oxidant mix to ultra high levels of UV energy. The system would comprise a sensor device (210) configured to detect known and unknown substances in the water flowing through the pipe (202). FIG. 5 is a flow chart showing one example embodiment of the current invention. At step 506 the flow of water through the system is monitored. If there are no substances detected in the water the process returns to step 506. When a substance is detected an oxidant is added (502) to the flow through the system. Different oxidants may require different flow rates. At step 504 the oxidant and water mixture is exposed to ultra high levels of UV energy. In the preferred embodiment, the ultra high energy UV light is generated using a pulsed UV system and the oxidant used is Oxone®. With this combination the system is small in size and can be turned on quickly, even after long periods of inactivity.

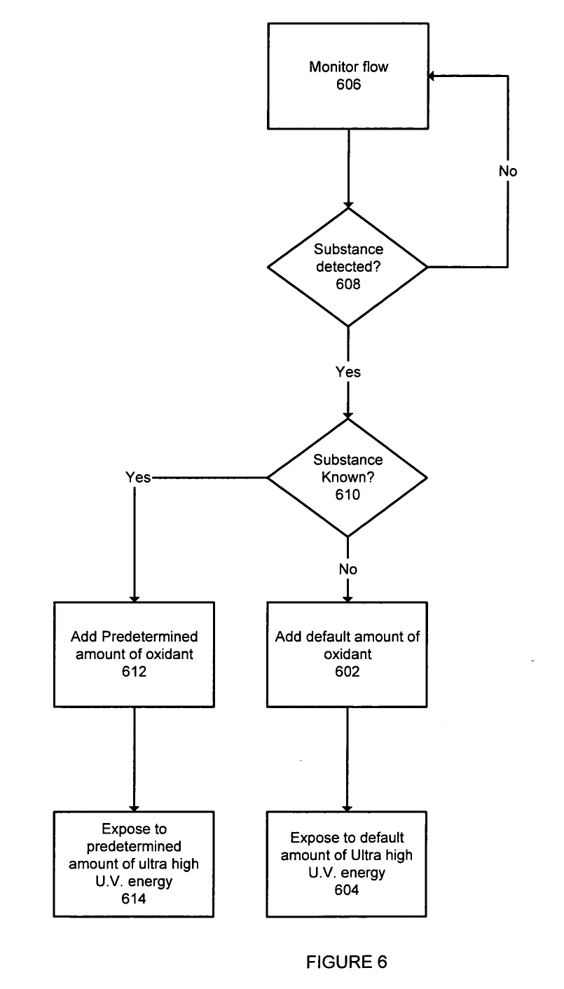

One type of sensor system that may be used is disclosed in co-pending patent application 60/438,358 filed on Jan. 7, 2003 entitled “Classification of Deviations in a Process” with Karl L. King as the first named inventor, which is hereby incorporated by reference. Using a sensor as disclosed in the King et. al. patent application, substances may not only be detected, but also identified. FIG. 6 is a flow chart in another example embodiment of the current invention. At step 606 the water flowing through the system is monitored. If there are no substances detected then the process returns to step 606. When a substance is detected, its signature is compared to the signatures of all the substances in the database. If there is a match then the substance has been identified. If there is no match then the substance is unknown. When the substance is known, a predetermined rate of oxidant is added to the water flow (612). The predetermined rate for different substances may be different, based on the susceptibility of the substance to degradation. The different predetermined rates may also depend on the type of oxidant being used. If more than one substance is detected and the two substances have a different predetermined rate, the higher of the two rates may be used, or a third rate may be used. Once the oxidant has been added, the water is exposed to a predetermined amount of ultra high UV energy (614). The predetermined amount of energy for different substances may be different, based on the susceptibility of the substance to degradation. The predetermined amount of energy may also depend on the type of oxidant being used. If more than one substance is detected and the two substances have different predetermined energy amounts, the higher of the two amounts may be used, or a third amount may be used. The UV energy level can be varied by changing the intensity of the UV radiation. When using pulsed UV light, the energy level may be changed by changing the pulse duration, the intensity of the pulse, the number of pulses per second, or a combination of pulse length, pulse rate and intensity level. The wavelength of the peak UV energy may also be varied. When the substance is unknown a default level of oxidant is added to the flow of water (602) and then the water is exposed to a default level of ultra high UV energy (604). The default levels may be a maximum oxidation rate and maximum UV energy or some other combination of oxidant rates and energy levels.

Some sensors can detect the concentration of the substance in the water, for example inductively coupled plasma-mass spectrometry (ICPMS), GCMS, MENs, Lab on a chip, and ion mobility spectroscopy. The treatment levels may be changed based on the concentration of the detected substances. For example, when the concentration of the substance is high the treatment level would be increased. The treatment may be increased by increasing the amount of oxidant added per unit volume of water, or by increasing the amount of UV energy, or by some combination of the two. When using pulsed UV light, the energy level may be changed by changing the pulse duration, the intensity of the pulse, the number of pulses per second, or a combination of pulse length, pulse rate and intensity level.

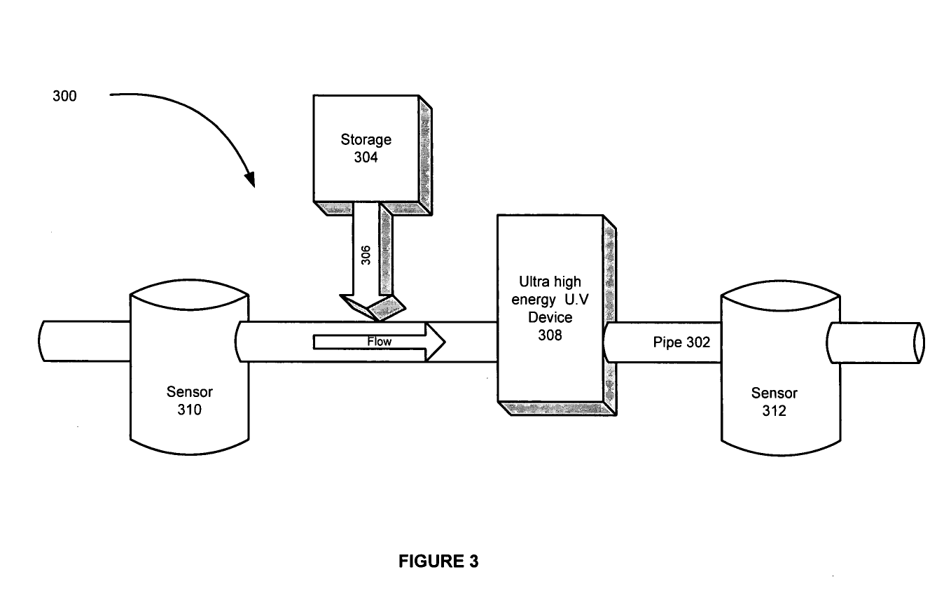

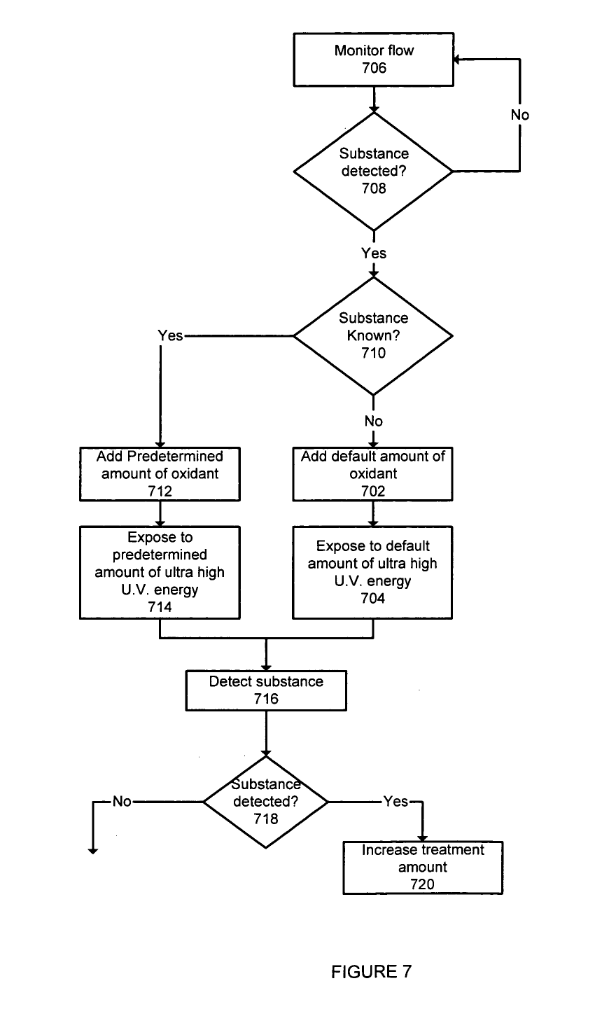

FIG. 3 shows another example embodiment of the invention. The system (300) would couple to a pipe (302) in the water distribution system. The system would comprise a storage area (304) for storing an oxidant that is used by the system. The storage area (304) would be coupled to a metering and feed device (306) used to control the flow rate of oxidant into the water distribution system. The system would comprise an ultra high energy UV source (308) configured to expose the water and oxidant mix to ultra high levels of UV energy. The system would comprise an upstream sensor device (310) configured to detect known and unknown substances in the water flowing through the pipe (302). The system would also comprise a downstream sensor (312) configured to detect substances in the flow. In operation the downstream sensor (312) would be used as a check to confirm that the substance had been destroyed by the system. FIG. 7 is a flow chart showing one example embodiment of the current invention. At step 706 the flow of water through the system is monitored. If there are no substances detected in the water the process returns to step 706. When a substance is detected, its signature is compared to the signatures of all the substances in the database. If there is a match then the substance has been identified. If there is no match then the substance is unknown. When the substance is known, a predetermined rate of oxidant is added to the water flow (712). The predetermined rate for different substances may be different, based on the susceptibility of the substance to degradation. If more than one substance is detected and the two substances have a different predetermined rate, the higher of the two rates may be used, or a third rate may be used. Once the oxidant has been added, the water is exposed to a predetermined amount of ultra high UV energy (714). The predetermined amount of energy for different substances may be different, based on the susceptibility of the substance to degradation. If more than one substance is detected and the two substances have different predetermined energy amounts, the higher of the two amounts may be used, or a third amount may be used. Once the water and oxidant have been exposed to the ultra high UV energy, the water is monitored for substances (716). When the substances have been destroyed, no action is taken. When the substances have not been fully destroyed, the treatment is increased (720). The treatment may be increased by increasing the amount of oxidant added per unit volume of water, or by increasing the amount of UV energy, or by some combination of the two. When the substance is detected at step 718, other actions in addition to increasing the treatment rate may be taken. For example, when the substance is still detected after treatment the system may be configured to shut off the water supply to the protected target. Or the system may be configured to divert the water flow (not shown) as the treatment level is increased, until the monitored water becomes free of substances. The water may be diverted into the sewer system or may be diverted into a storage area for further treatment. In another embodiment the system may be configured to divert the flow of water back through the system (not shown) until all of the substances have been destroyed.

When the substance is unknown a default level of oxidant is added to the flow of water (702) and then the water is exposed to a default level of ultra high UV energy (704). Once the water and oxidant have been exposed to the ultra high UV energy, the water is monitored for substances (716). The process continues in step 718 as describe above. In the preferred embodiment, the ultra high energy UV light is generated using a pulsed UV system and the oxidant used is Oxone®. With this combination the system is small in size and can be turned on quickly, even after long periods of inactivity.

In another example embodiment of the invention (not shown), the treatment system only has one sensor system placed in a downstream position. By placing the sensor in the downstream location, the sensor may be used as a trigger to start the system when a substance is detected, and also used as a feedback control to ensure that all the substances have been destroyed. This may save cost compared to the two sensor design. Unfortunately some substances must have already passed through the system before detection can occur. To prevent the contaminated water from reaching the protected facility, the water flow may be diverted until the treatment system has been activated and all of the substances are being destroyed in the water flow.

The flow of water through the systems used in the examples above have been shown as simple straight line configurations for clarity. In operation, the flow of water through the systems may be more complex. For example, to expose the water to the proper level of UV energy, there may be multiple UV sources, or the water may make multiple passes through the UV source. There may be flow control devices configured to control the flow of water through the UV source to allow the water to be exposed to the UV energy for a controlled duration. The water may not flow through all of the system until a substance has been detected. For example the water may not be flowing through the UV source until a triggering event occurred.

1. A method, comprising:
monitoring for the occurrence of an event;
responding to the occurrence of the event by adding an oxidant to water and then exposing the water and oxidant to an ultra high energy UV light.

2. The method of claim 1 further comprising:
testing the exposed water and oxidant to determine when a substance in the water has been destroyed.

3. The method of claim 1 where the event is the notification that a substance has been detected in the water.

4. The method of claim 1 where monitoring for the occurrence of an event comprises testing the water for the presence of a substance in the water.

5. The method of claim 1 where the water is in a water distribution system.

6. The method of claim 1 where the oxidant is Oxone®.

7. A method, comprising:
testing water flowing through a water distribution system for substances;
treating the water flowing through the water distribution system when a substance is detected, where treating comprises;
adding an oxidant to the water; and
exposing the water and oxidant to an ultra high energy UV radiation.

8. The method of claim 7 further comprising:
identifying the detected substance.

9. The method of claim 8 where a treatment level is varied dependent on which substance is identified, where the treatment level is a function of the amount of oxidant added to the water and the amount of UV energy used during the exposure.

10. The method of claim 7 further comprising:
determining the concentration of the detected substance.

11. The method of claim 10 where a treatment level is varied dependent on the concentration of the detected substance, where the treatment level is a function of the amount of oxidant added to the water and the amount of UV energy used during the exposure.

12. The method of claim 7 where the water is tested after the exposure to the ultra high energy UV light to determine if the detected substance has been destroyed.

13. The method of claim 12 where a treatment level is increased when the detected substance has not been destroyed, where the treatment level is a function of the amount of oxidant added to the water and the amount of UV energy used during the exposure.

14. The method of claim 7 where the oxidant is Oxone®.

15. The method of claim 7 where the ultra high energy UV radiation is generated using a pulsed UV light.

16. A apparatus, comprising:
a storage area configured to store an oxidant;
a metering and feed system coupled to the storage area and coupled to a water distribution system, the metering and feed system configured to control a flow of the oxidant into water flowing in the water distribution system;
an ultra high energy ultra violet (UV) source configured to expose the water and oxidant mix to ultra high energy UV radiation;
the apparatus configured to start the flow of oxidant into the water and to begin exposing the water and oxidant mix to the ultra high energy UV at the occurrence of an event.

17. The apparatus of claim 15 further comprising:
a first sensor configured to signal the occurrence of an event when a substances is detected in the water flowing through the water distribution system.

18. The apparatus of claim 17 where the first sensor is a downstream sensor.

19. The apparatus of claim 17 further comprising:
a second sensor configured to determine when the substances in the water have been destroyed.

20. The apparatus of claim 19 further comprising:
a valve configured to divert the water from the water distribution system when the substance in the water has not been destroyed.

21. The apparatus of claim 16 where the ultra high energy UV source can very the power level of the UV energy.

22. The apparatus of claim 16 where the stored oxidant is Oxone®.

23. The apparatus of claim 16 where the ultra high energy ultra violet (UV) source is a pulsed UV light.

24. An apparatus comprising:
a means for monitoring water flowing through a water distribution system;
a means for adding an oxidant to the water flowing through the water distribution system when a substance is detected in the water;
a means for exposing the water and oxidant mix to ultra high energy UV radiation when the substance is detected in the water.
